(19) United States
(12) Patent Application Publication
(10) Pub. No.: US 2026/0196885 A1
(43) Pub. Date: Jul. 9, 2026

(54) STATOR FOR AN ELECTRICAL MACHINE, HAVING A DEVICE FOR COOLING THE STATOR

(71) Applicant: VALEO EAUTOMOTIVE GERMANY GMBH, Erlangen (DE)

(72) Inventor: Philipp SÖNTGERATH, Erlangen (DE)

(73) Assignee: VALEO EAUTOMOTIVE GERMANY GMBH, Erlangen (DE)

(21) Appl. No.: 18/997,694

(22) PCT Filed: Jul. 12, 2023
(86) PCT No.: PCT/EP2023/069368

§ 371 Date: Jan. 22, 2025

(30) Foreign Application Priority Data
Jul. 29, 2022 (DE) 10 2022 207 889.6

(51) Int. Cl. H02K 1/20; H02K 5/20; H02K 15/026

(52) U.S. Cl. CPC H02K 1/20; H02K 5/203; H02K 15/026

(57) ABSTRACT

A stator for an electric machine includes a laminated stator core and stator windings, which are designed for generating an electrical rotating field in an current-carrying state, and has a device for cooling the stator with a cooling liquid. The device includes a hollow-cylindrical stator jacket which surrounds the laminated stator core and the stator windings and has a radial inlet, formed on the internal side of the stator jacket being helically extending protrusions which conjointly with the external side of the laminated stator core form ducts for the cooling liquid. The stator may be implemented in an electric machine, and a vehicle may implement such electric machine.

The invention relates to a stator for an electric machine, having a laminated stator core and stator windings which are designed to generate a rotating electrical field in an current-carrying state, and having a device for cooling the stator with a cooling liquid.

Electric machines of this type are increasingly used in electrically powered vehicles or hybrid vehicles. Such an electric machine is mainly used as an electric motor for driving a wheel or an axle of a vehicle. The electric motor can be designed, inter alia, as a synchronous motor or asynchronous motor.

The electric motor is in most instances mechanically coupled to a gear unit for speed adjustment. Moreover, the electric motor is usually electrically connected to an inverter that generates an AC voltage, in particular a multi-phase AC voltage, for the operation of the electric machine from a DC voltage supplied by a battery.

It is also possible to operate the electric machine as a generator for recuperating kinetic energy of a vehicle, wherein the kinetic energy is first converted into electrical energy and then into chemical energy of the battery.

The stator of a conventional electric machine usually has a laminated stator core and stator windings. When a current is applied to the stator windings, an electrical rotating field is generated, which causes a rotor to rotate.

During operation of the electric machine, the stator, inter alia, is heated up considerably, wherein the heat generated is proportional to the applied electrical current. A particularly large amount of heat is generated when the electric machine is operated at a high output. In the process, certain components of the electric machine, such as the stator windings, can however reach their thermal load limits.

In order to be able to dissipate the resulting heat, the stator usually has a cooling device. The cooling device may include a cooling duct that can be passed through by a flow of liquid coolant. The coolant, which can be for example a water/glycol mixture or an oil, is conveyed in a circuit. This allows the temperature of the stator windings to be kept below a specified limit even under high loads.

The cooling of a stator should be as uniform as possible in order to avoid local hot spots. For this purpose, conventional electric machines are equipped with, for example, a cooling jacket which is passed through by a flow of water. However, the provision of a cooling jacket requires that the cooling jacket is integrated into the structure of the electric machine.

There is therefore a need for a stator having a cooling device which is easy to integrate.

For achieving this object, it is provided according to the invention in a stator of the type mentioned at the outset that the device comprises a hollow-cylindrical stator jacket which surrounds the laminated stator core and the stator windings and has a radial inlet, formed on the internal side of the stator jacket being helically extending protrusions which conjointly with the external side of the laminated stator core form ducts for the cooling liquid.

The invention is based on the finding that a stator can be provided particularly easily with a cooling device by the cooling device being disposed on the external side of the laminated stator core. For this purpose, the laminated stator core is surrounded by a stator jacket which is designed as a hollow cylinder. In the interior of this hollow cylinder there are helical protrusions which conjointly with the external side of the laminated stator core form cooling ducts.

Such a stator has the advantage that no modification of the laminated stator core is required. The stator jacket can easily be attached to the external side, forming the cooling ducts as a result. Accordingly, a stator can be provided in an extremely simple manner with a cooling device for a cooling liquid, in which cooling takes place from the external side of the laminated stator core.

In the context of the invention, it can be provided that the radial inlet for the cooling liquid in terms of the axial direction is disposed at least approximately in the center of the stator jacket, and the helical ducts for the cooling liquid extend from the inlet to both axial ends of the stator jacket. Such an arrangement of the inlet and the ducts ensures that the cooling liquid supplied from the center of the stator jacket flows in the direction of the two ends of the stator jacket, thereby dissipating heat particularly evenly.

In order to simplify the production of the stator according to the invention, it is particularly preferred that the stator jacket has a first half-shell and connected thereto a second half-shell. The two half-shells are first positioned around the laminated stator core and then connected to one another. Preferably, the two half-shells can be welded and/or adhesively bonded and/or latched to one another. In this way, the laminated stator core comprising the stator windings can be provided with the stator jacket in a comparatively late assembly step.

Preferably, interconnected edges of the half-shells define a separating plane in which the first half-shell has one or a plurality of recesses and the second half-shell has one or a plurality of protrusions which are formed so as to be complementary to the recesses and are inserted into the recesses and/or latched thereto. By latching the two half-shells, the latter can be connected particularly easily to one another.

Preferably, the two half-shells that form the stator jacket are produced from a plastics material.

The half-shells can furthermore preferably be produced by injection molding.

In order to ensure cooling of winding heads of the stator windings, it is preferred that a ring having passage openings is disposed on one axial side or on both axial sides of the stator. Coolant supplied via the cooling ducts can be supplied to the winding heads of the stator windings by way of this ring, in particular by way of passage openings disposed in the ring, in order to cool the stator windings.

The invention also relates to a method for producing a stator of the type described for an electric machine, comprising the following method steps:
providing a laminated stator core which is provided with stator windings;
disposing a first half-shell and a second half-shell of a stator jacket around the laminated stator core; and
connecting the first half-shell and the second half-shell in order to form the hollow-cylindrical stator jacket.

Moreover, the invention relates to an electric machine having a stator of the type described, which surrounds a rotor that is rotatable relative to the stator.

Optionally, the electric machine can have a housing that surrounds the stator. However, this may also be an electric machine which has no housing and in which the external side is formed by the stator per se and by two axial covers or flanges.

In the electric machine according to the invention, the cooling liquid can comprise an oil.

A refinement of the electric machine according to the invention provides that the latter has a flange having a plurality of passage openings for fastening the electric machine, wherein the inlet for the cooling liquid of the stator jacket is disposed in the circumferential direction so as to be adjacent to one of the passage openings. Such an arrangement is particularly space-saving as the inlet does not extend beyond the outer contour of the flange.

Furthermore, the inlet can be disposed in such a way that it is co-aligned in the axial direction with the passage opening, which facilitates the installation of the electric machine in a vehicle.

The object on which the invention is based is furthermore achieved by a vehicle which has an electric machine according to the invention, which is configured for driving the vehicle.

In addition, the vehicle can have a gear unit which is coupled to the electric machine and/or an inverter which is connected to the machine and by way of which a multi-phase AC voltage required for operating the electric machine can be provided.

The invention will be explained hereunder with reference to exemplary embodiments with reference to the drawings. The drawings are schematic illustrations in which:

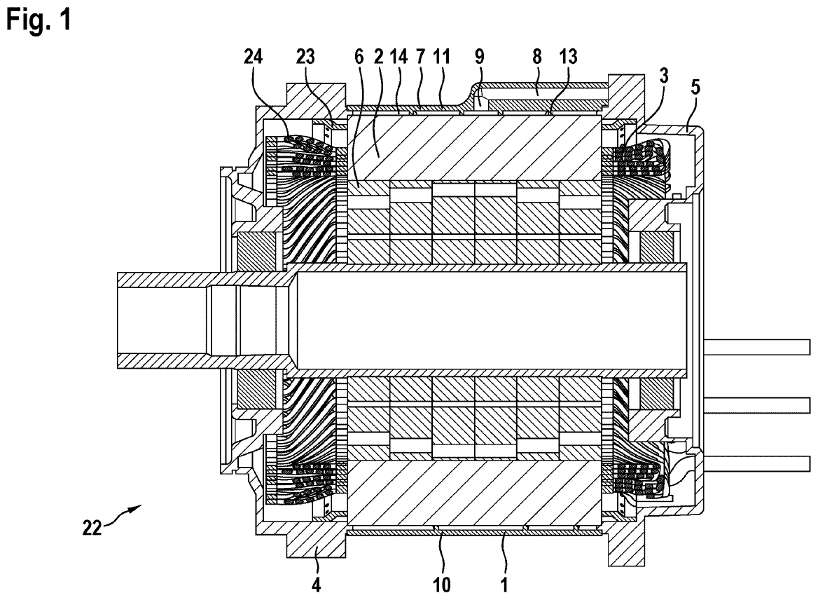

FIG. 1 shows a sectional view of an electric machine having a stator according to the invention;

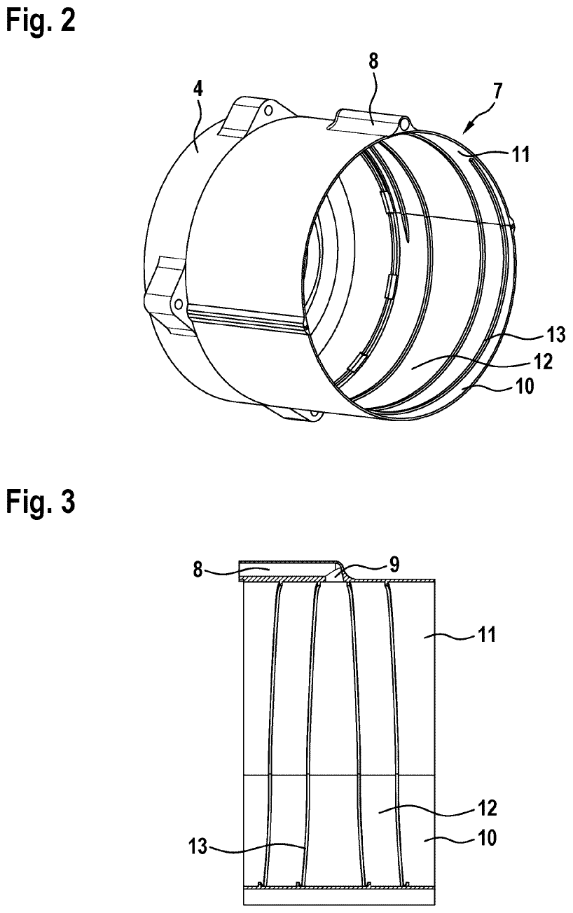

FIG. 2 shows a perspective view of a stator jacket connected to a flange;

FIG. 3 shows a sectional view of the internal side of the stator jacket;

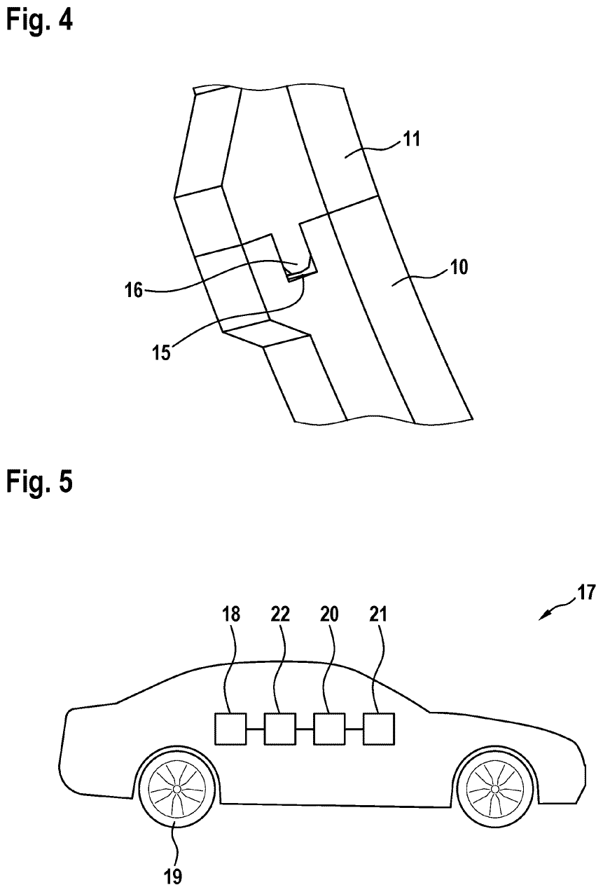

FIG. 4 shows an enlarged detail of the separating plane of two interconnected half-shells of the stator jacket; and

FIG. 5 shows a motor vehicle according to the invention.

FIG. 1 shows a sectional view of an electric machine 22 having a stator 1 according to the invention. The stator 1 comprises a laminated stator core 2 and stator windings 3. When a current is applied, the stator windings 3 generate an electrical rotating field.

On the left-hand side in FIG. 1, there is a flange 4, on the right-hand side in FIG. 1 there is an axial cover 5. A rotor shaft of a rotor 6 having a cavity is in the center of the stator 1. The flange 4 has a central opening which is penetrated by the rotor shaft.

The stator 1 has a device for cooling, which has a hollow-cylindrical stator jacket 7. It can be seen in FIG. 1 that the stator jacket 7 surrounds the laminated stator core 2 by way of the stator windings 3. The stator jacket 7 has a coolant line 8 which extends parallel to the axial direction and opens into a radial inlet 9. The coolant line 8 is connected to a coolant reservoir via a line not shown. By means of a pump, coolant is conveyed into the stator jacket 7 in a circuit that runs through the coolant line 8 and the radial inlet 9.

A ring 23 which has passage openings is in each case located on both axial sides of the stator windings 3, so as to be within the flange 4 or the axial cover 5, respectively, in order to direct coolant to winding heads 24 of the stator windings 3.

FIG. 2 shows a perspective view of the stator jacket 7 which is connected to the flange 4. It can be seen in FIG. 2 that the axially extending coolant line extends from an axial end to approximately the center of the stator jacket 7. The stator jacket 7 comprises a first half-shell 10 and a second half-shell 11, which are connected to one another and form the annular stator jacket 7.

FIG. 3 shows a sectional view of the stator jacket 7, showing the internal side of the latter. To be seen there are helically extending protrusions 13 which, proceeding from the inlet 9 for the coolant, extend symmetrically in both opposite axial directions. In the radial direction, the protrusions 13 extend to the external side of the stator windings 3. As a result, cooling ducts 14 which are delimited by the internal side 12 of the stator jacket 7, the helically extending protrusions 13 and the external side of the stator windings 3, are formed.

The cooling ducts 14 extend helically from the center of the stator jacket 7 outward in both axial directions. Accordingly, cooling liquid, which is supplied via the coolant line 8 and the inlet 9, is guided through the cooling ducts 14 helically about the external side of the stator jacket 7, whereby heat is optimally dissipated from the laminated stator core 2 and the stator windings 3. The temperature of the stator windings 3 can be delimited to a specified value when operating the electric machine 1.

FIG. 4 shows an enlarged fragment of the separating plane of the two interconnected half-shells 10, 11 of the stator jacket 7. The first half-shell 10 has a recess 15 which is formed as a groove extending over the entire axial length of the first half-shell 10. The second half-shell 11 has a protrusion 16 which is of a complementary design to the latter and also extends over the entire axial length of the second half-shell 11. Each half-shell 10, 11 possesses such a recess 15 and such a protrusion 16, on which the two half-shells 10, 11 can be latched to one another or pressed together to form the tubular stator jacket 7. In other embodiments, the connection of the two half-shells 10, 11 can also be produced by adhesive bonding or welding.

FIG. 5 shows a vehicle 17 having a drive train comprising the electric machine 22. The electric machine 22 is coupled to a wheel 19 of the vehicle 17 via a gear unit 18. Moreover, the electric machine 22 is electrically connected to an inverter 20. A battery 21 supplies a DC voltage which is converted by the inverter 20 into an AC voltage for the operation of the electric machine 22.

### LIST OF REFERENCE SIGNS

1 Stator
2 Laminated stator core
3 Stator windings
4 Flange
5 Axial cover
6 Rotor
7 Stator jacket
8 Coolant line
9 Inlet
10 First half-shell
11 Second half-shell
12 Internal side
13 Protrusion
14 Cooling duct
15 Recess
16 Protrusion
17 Vehicle
18 Gear unit
19 Wheel
20 Inverter
21 Battery
22 Electric machine
23 Ring
24 Winding head

1. A stator for an electric machine, having a laminated stator core and stator windings, which are designed for generating an electrical rotating field in an current-carrying state, and having a device for cooling the stator with a cooling liquid, characterized in that the device comprises a hollow-cylindrical stator jacket which surrounds the laminated stator core and the stator windings and has a radial inlet, formed on the internal side of the stator jacket being helically extending protrusions which conjointly with the external side of the laminated stator core form ducts for the cooling liquid.

2. The stator as claimed in claim 1, wherein the inlet for the cooling liquid in terms of the axial direction is disposed at least approximately in the center of the stator jacket, and the helical ducts for the cooling liquid extend from the inlet (9) to both axial ends of the stator jacket.

3. The stator as claimed in claim 1, wherein the stator jacket has a first half-shell and connected thereto a second half-shell.

4. The stator as claimed in claim 3, wherein the two half-shells are welded and/or adhesively bonded and/or latched to one another.

5. The stator as claimed in claim 3, or wherein interconnected edges of the half-shells define a separating plane in which the first half-shell has one or a plurality of recesses and the second half-shell has one or a plurality of protrusions which are formed so as to be complementary to the recesses and are inserted into the recesses and/or latched thereto.

6. The stator as claimed in claim 3, wherein the two half-shells are produced from a plastics material.

7. The stator as claimed in claim 3, wherein the two half-shells are produced by injection molding.

8. The stator as claimed in claim 1, wherein disposed on one axial side or on both axial sides of the stator is in each case one ring having passage openings in order to supply coolant from the ducts to winding heads of the stator windings.

9. A method for producing a stator for an electric machine as claimed in claim 1, comprising the following method steps:
providing a laminated stator core having stator windings
disposing a first half-shell and a second half-shell of a stator jacket around the laminated stator core and
connecting the first half-shell and the second half-shell in order to form the hollow-cylindrical stator jacket.

10. An electric machine having a stator as claimed in claim 1, which surrounds a rotor that is rotatable relative to the stator.

11. The electric machine as claimed in claim 10, wherein the cooling liquid comprises an oil.

12. The electric machine as claimed in claim 10, having a flange having a plurality of passage openings for fastening the electric machine, wherein the inlet for the cooling liquid of the stator jacket is disposed in the circumferential direction so as to be adjacent to one of the passage openings.

13. The electric machine as claimed in claim 12, wherein the inlet is co-aligned in the axial direction with the passage opening.

14. A vehicle having an electric machine as claimed in claim 10, which is configured for driving the vehicle.

15. The stator as claimed in claim 2, wherein the stator jacket has a first half-shell and connected thereto a second half-shell.

16. The stator as claimed in claim 4, wherein interconnected edges of the half-shells define a separating plane in which the first half-shell has one or a plurality of recesses and the second half-shell has one or a plurality of protrusions which are formed so as to be complementary to the recesses and are inserted into the recesses and/or latched thereto.

17. The stator as claimed in claim 4, wherein the two half-shells are produced from a plastics material.

18. The stator as claimed in claim 4, wherein the two half-shells are produced by injection molding.

19. The stator as claimed in claim 2, wherein disposed on one axial side or on both axial sides of the stator is in each case one ring having passage openings in order to supply coolant from the ducts to winding heads of the stator windings.

20. A method for producing a stator for an electric machine as claimed in claim 2, comprising the following method steps:
providing a laminated stator core having stator windings;
disposing a first half-shell and a second half-shell of a stator jacket around the laminated stator core; and
connecting the first half-shell and the second half-shell in order to form the hollow-cylindrical stator jacket.
